(19) United States
(12) Patent Application Publication
(10) Pub. No.: US 2012/0319408 A1
(43) Pub. Date: Dec. 20, 2012

(54) AIRFLOW BASED MICROTURBINE POWER SUPPLY

(75) Inventor: VADIM PLOTSKER, Amherst, NH (US)

(73) Assignee: BAE SYSTEMS INFORMATION AND ELECTRONIC SYSTEMS INTERGRATION INC.

(21) Appl. No.: 13/523,913

(22) Filed: Jun. 15, 2012

Related U.S. Application Data
(60) Provisional application No. 61/498,009, filed on Jun. 17, 2011.

(30) Foreign Application Priority Data
Jun. 15, 2012 (IN) 2384/CHR/2012

(51) Int. Cl. H02K 7/18

(52) U.S. Cl. 290/1 A

(57) ABSTRACT

An airflow based microturbine power supply is disclosed. In one embodiment, the airflow based microturbine power supply includes at least one microturbine configured to circulate upon receiving airflow and to convert to mechanical energy. Further, the airflow based microturbine power supply includes a generator coupled to the at least one microturbine to convert the mechanical energy of the microturbine into electrical energy via electromagnetic induction.

### CROSS-REFERENCE TO RELATED APPLICATIONS

This application claims rights under 35 USC §119(e) from U.S. application Ser. No. 61/498,009 filed Jun. 17, 2011, and under 35 U.S.C. 119(a)-(d) to Foreign Application Serial No. 2384/CHE/2012 filed in INDIA entitled “AIRFLOW BASED MICROTURBINE POWER SUPPLY” filed on Jun. 15, 2012, and the contents of which are incorporated herein by reference.

### BACKGROUND OF THE INVENTION

1. Field of the Invention

The present invention relates to turbine power supplies, more specifically to airflow based microturbine power supplies.

2. Brief Description of Related Art

Generally, handheld and portable electronic devices need a power source. Further, these devices require regular recharging and create a constant demand for energy. Typical power sources for these devices include batteries and solar or plug-in power supply chargers. Frequently, the batteries run out of power and must be regularly disposed of or recharged. The plug-in power supply chargers require access to a generator or power supply, while the solar power supply chargers require access to sunlight. Furthermore, these power source solutions require the user to halt use of the device in order to recharge it.

### SUMMARY OF THE INVENTION

An airflow based microturbine power supply is disclosed. According to one aspect of the present subject matter, the airflow based microturbine power supply includes at least one microturbine configured to circulate upon receiving airflow and to convert to mechanical energy. Further, the airflow based microturbine power supply includes a generator coupled to the at least one microturbine to convert the mechanical energy of the at least one microturbine into electrical energy via electromagnetic induction. Furthermore, the airflow based microturbine power supply includes an output device coupled to the generator to receive the electrical energy and transfer to an external device.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 is a block diagram including major components of an airflow based microturbine power supply, according to an embodiment of the present subject matter.

### DETAILED DESCRIPTION OF THE INVENTION

The exemplary embodiments described herein in detail for illustrative purposes are subject to many variations in structure and design.

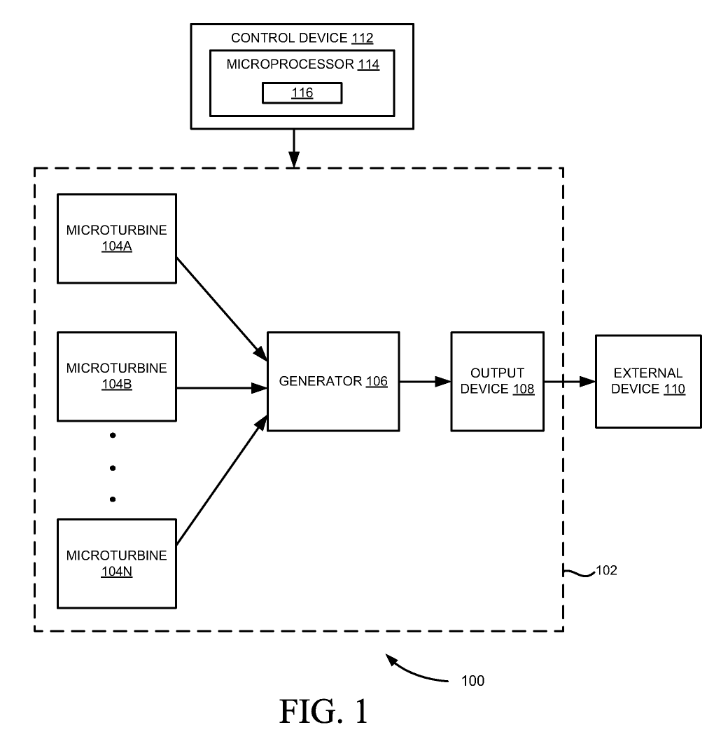

FIG. 1 is a block diagram 100 including major components of an airflow based microturbine power supply 102, according to an embodiment of the present subject matter. As shown in FIG. 1, the block diagram 100 includes the airflow based microturbine power supply 102, an external device 110, and a control device 112. Further, the airflow based microturbine power supply 102 includes a plurality of microturbines 104A-N, a generator 106, and an output device 108. Furthermore, the control device 112 includes a microprocessor 114. In addition, the microprocessor 114 includes embedded software 116. Moreover, the plurality of microturbines 104A-N is coupled to the generator 106. For example, the plurality of microturbines 104A-N is rotatably coupled to the generator 106. Also, the output device 108 is coupled to the external device 110. Further, the control device 112 is coupled to the airflow based microturbine power supply 102. In one exemplary implementation, the control device 112 controls the operation of the airflow based microturbine power supply 102.

In one embodiment, at least one of the plurality of microturbines 104A-N is configured to circulate upon receiving airflow and to convert to mechanical energy. For example, the airflow based microturbine power supply 102 is configured to attach to a surface, such as a person, an article of clothing, a weapon, a handheld device and the like. For example, the airflow is generated from movements of body of the person, the handheld devices, the weapons, the article of clothing and the like. In one exemplary implementation, the at least one of the plurality of microturbines 104A-N spins as the airflow passes over and through the at least one of the plurality of microturbines 104A-N. For example, the airflow based microturbine power supply 102 utilizes kinetic energy of the handheld devices, weapons, or other devices used by a soldier to power the at least one of the plurality of microturbines 104A-N. In another exemplary implementation, an airtight chamber substantially surrounding the at least one of the plurality of microturbines 104A-N captures the airflow generated from the movements of body of the person, the handheld devices, the weapons, the article of clothing and the like. Within the airtight chamber, any motion that compresses one area of the airtight chamber creates airflow throughout the rest of the airtight chamber. For example, the airtight chamber is an outfit worn by the person, a casing, and/or a cover for a device. The airtight chamber is further configured to direct the airflow towards the at least one of the plurality of microturbines 104A-N to cause the at least one of the plurality of microturbines 104A-N to spin in reaction to the directed airflow.

Further in this embodiment, the generator 106 converts the mechanical energy of the at least one of the plurality of microturbines 104A-N into electrical energy via electromagnetic induction. Furthermore, the output device 108 receives the electrical energy from the generator 106 and transfer to the external device 110. For example, the output device 108 includes devices, such as a superconducting magnetic energy storing device, a battery, an electrical capacitor and the like for storing the electrical energy. For example, the external device 110 includes handheld electronic devices, portable electronic devices and the like.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. An airflow based microturbine power supply, comprising:
at least one microturbine configured to circulate upon receiving airflow and to convert to mechanical energy; and
a generator coupled to the at least one microturbine to convert the mechanical energy of the at least one microturbine into electrical energy via electromagnetic induction.

2. The power supply of claim 1, wherein the airflow based microturbine power supply is configured to attach to a surface selected from the group consisting of a person, an article of clothing, a weapon and a handheld device.

3. The power supply of claim 2, wherein the airflow is generated from movements of body of the person, the handheld devices, the weapons and/or the article of clothing.

4. The power supply of claim 3, further comprising:
an airtight chamber substantially surrounding the at least one microturbine, wherein the airflow generated by the movements of the body of the person, the handheld devices, the weapons and/or the article of clothing is captured in the airtight chamber and wherein the airtight chamber is further configured to direct the airflow towards the at least one microturbine to cause the at least one microturbine to spin in reaction to the directed airflow.

5. The power supply of claim 4, wherein the airtight chamber is an outfit worn by the person, a casing, and/or a cover for a device.

6. The power supply of claim 1, further comprising:
an output device coupled to the generator to receive the electrical energy and transfer to an external device.

7. The power supply of claim 6, wherein the output device comprises devices for storing the electrical energy, wherein the devices are selected from the group consisting of a superconducting magnetic energy storing device, a battery and/or an electrical capacitor.

8. The power supply of claim 1, wherein the at least one microturbine is rotatably coupled to the generator.

9. The power supply of claim 1, further comprising a control device to control the operation of the airflow based microturbine power supply.

10. The power of supply of claim 9, wherein the control device includes a microprocessor and embedded software.
